(19) United States
(12) Patent Application Publication
(10) Pub. No.: US 2016/0299753 A1
(43) Pub. Date: Oct. 13, 2016

(54) FIRMWARE UPGRADING METHOD FOR BLUETOOTH ELECTRONIC SCALES

(71) Applicant: Rex Poway Tseng, Taipei (TW)

(72) Inventor: Rex Poway Tseng, Taipei (TW)

(21) Appl. No.: 14/563,870

(22) Filed: Apr. 9, 2015

(51) Int. Cl. G06F 9/445; H04W 4/00

(52) U.S. Cl. CPC G06F 8/65; H04W 4/008

(57) ABSTRACT

A firmware upgrading method for Bluetooth electronic scales. The firmware upgrading method provides a function to resume firmware upgrading for the Bluetooth electronic scale, and conduct the Bluetooth electronic scale firmware upgrading through batch-by-batch transmission of the data packets containing parameter information. The steps include: Establish Bluetooth networking, Transmit data packets, Compare the data packets in stages, Record the firmware upgrading progress, and Check completeness of the upgrading. In view of the problem that general Bluetooth networking is unable to ensure correctness of the data transmitted, the firmware upgrading method of the present invention can be applied for communication between a Bluetooth mobile device and a Bluetooth electronic scale paired through Bluetooth networking, and ensure correctness of the data packets received. Even if the Bluetooth transmission is paused due to disconnection, the firmware upgrading can be resumed and successfully completed.

### BACKGROUND OF INVENTION

1. Field of the Invention

The present invention relates generally to a firmware upgrading method for Bluetooth electronic scales, and more particularly to a firmware upgrading method used to establish a networking between a Bluetooth electronic scale and a Bluetooth mobile device, and to upgrade the firmware program of the Bluetooth electronic scale.

2. Description of Related Art

A conventional electronic scale can detect and display the weight value of the measured object placed on the scale pan. More advanced electronic scales may be configured with communication interfaces and connection ports to be connected with external electronic devices through concrete transmission cables. However, there must be a networked environment to transmit data and download firmware upgrading files. Types of connection ports of such electronic scales include parallel port, serial port (RS232), Universal Serial Bus (USB) or I²C (Inter-Integrated Circuit) serial communication bus. Such connection ports are exposed in the environment and have limited dustproof and waterproof effects. Meanwhile, the internal electronic components and devices are susceptible oxidation and dampness, which may cause inaccurate measurement and shorter lifecycle.

To solve the above problems, the present invention evaluated a wireless transmission technology that does not need a networked environment, i.e., Bluetooth, which is a new generation wireless transmission technology widely used across the world. Using universal RF 2.4 GHz radio interfaces and based on technical standards defined by the Bluetooth Special Interest Group (SIG), this wireless transmission technology can establish wireless short-distance connection between different electronic devices, for example, between a computer and peripheral equipment like printer, keyboard, earphone etc. With the Bluetooth wireless transmission technology, smart phones and wearable devices can wirelessly obtain data from a short distance, getting rid of the troublesome concrete transmission cables. Comparing to infrared transmission which only allows linear point-to-point connection, the Bluetooth technology can establish connection as long as the distance is within the effective range, even when there are barriers, and its transmission speed is higher.

Due to on-going development of the Bluetooth wireless transmission technology, Bluetooth 4.0 or higher versions are capable of two-way, long-distance and high-speed transmission with low power consumption. However, as a matter of fact, Bluetooth networking is unable to ensure continuous connection and completely reliability of the data transmitted. Moreover, when using mobile phone communications and operating Application Software (APP) based on 802.11b/g wireless networking (i.e., networking using WiFi Standard), there may be occurrence of forced pause or disconnection of the Bluetooth networking, causing higher inaccuracy of the data packet, and even higher chances of losing the data packet. The reason of forced pause/disconnection of Bluetooth networking is that the transmission frequency bands of the Bluetooth, remote controls, WiFi, and microwave used by microwave ovens all fall on 2.4 GHz, and therefore the Bluetooth transmission is easily disturbed. Further reason of the transmission interruption and failure is that, during the firmware upgrading process, there is no two-way (transmitting/receiving) interactive comparing and checking of the correctness of all the incoming data packets, which lead to failure of the firmware upgrading, and subsequent failure of the operation of the Bluetooth device.

### SUMMARY OF THE INVENTION

The main objective of the present invention is to provide a firmware upgrading method for Bluetooth electronic scales. The firmware upgrading method is developed as a solution to the problem that Bluetooth networking is unable to ensure reliability of the data transmitted. Through the Bluetooth mobile device establishing a Bluetooth networking, the transmitted data packets are compared and checked to avoid data transmission error, and the firmware upgrading progress is recorded for resumed transmission to successfully complete the Bluetooth electronic scale firmware upgrading.

The secondary objective of the present invention is to provide an electronic scale with a highly attractive appearance, with no compromise of measuring accuracy, lower power consumption and longer lifecycle. Through adoption of the Bluetooth technology, all concrete cable transmission ports are removed.

To fulfill the above objectives, the present invention provides a firmware upgrading method for Bluetooth electronic scales. The firmware upgrading method provides a function to resume firmware upgrading for the Bluetooth electronic scale, and conduct the Bluetooth electronic scale firmware upgrading through batch-by-batch transmission of the data packets containing parameter information. The steps include: Establish Bluetooth networking, transmit data packets, compare data packets in stages, record firmware upgrading progress and check completeness of upgrading. In view of the problem that general Bluetooth networking is unable to ensure correctness of the data transmitted, the firmware upgrading method of the present invention can be applied for communication between a Bluetooth mobile device and a Bluetooth electronic scale paired through Bluetooth networking, and ensure correctness of the data packets received. Even if the Bluetooth transmission is paused due to disconnection, the firmware upgrading can be resumed and successfully completed.

Said step to establish Bluetooth networking is as follow: the Bluetooth mobile device has a built-in APP Application Software program, and further has an electronic scale firmware program to conduct two-way communication with the ISP program (In System Programming) provided in the Bluetooth electronic scale. The electronic scale firmware program transmits data packets containing parameter information batch by batch, which are received by the ISP program.

Said Bluetooth electronic scale further comprises a central processor, a memory, and an ISP program, with the central processor being the processing core and command executing unit, and the memory is divided into a general Programming Block and an ISP Programming Block (In System Programming Block) through address plan. The ISP program is loaded in the ISP Programming Block, and executed by the central processor to load the received electronic scale firmware program in the general Programming Block.

Said Bluetooth mobile device further comprises a central processor, a cache, a touch screen. The APP application uses the central processor as core computing and command executing unit. The APP application and the electronic scale firmware program are respectively saved in the cache through address plan.

Said step to compare the data packets in stages is a two-stage comparing and checking mechanism. Respectively, the ISP program is provided with a first-stage comparing system to ensure correctness of the packets received, and the APP application is provided with a second-stage comparing system to ensure correctness of the electronic firmware program loaded in the memory.

Said APP application and ISP program transmit, to each other, data packets containing parameter information. The data packets are mainly classified into version data packet, firmware data packet, and frame data packet. Any of the above data packets is a packet assembly containing file header information and packet checksum.

Said step to record the firmware upgrading progress provides a function to resume the firmware upgrading for the Bluetooth electronic scale. The ISP program is provided with a receiving progress variable to record the firmware upgrading progress, and to realize the function to resume the transmission and upgrading.

### BRIEF DESCRIPTION OF THE DRAWINGS

FIG. 1 is a schematic view of the orders of the firmware upgrading method of the present invention.

FIG. 2 is a schematic view of the Bluetooth mobile device of the present invention.

FIG. 3 is a schematic view of the Bluetooth electronic scale of the present invention.

FIG. 4 is a schematic view of the networking and data transmission between the Bluetooth mobile device and the Bluetooth electronic scale of the present invention.

FIG. 5 is a schematic view of the data packet categories of the present invention.

FIG. 6 is a schematic view of the first-stage firmware data packet comparing and checking of the present invention.

FIG. 7 is a schematic view of the second-stage firmware data packet comparing and checking of the present invention.

FIG. 8 is a schematic view of the Bluetooth electronic scale firmware upgrading processes of the present invention.

### DETAILED DESCRIPTION OF THE INVENTION

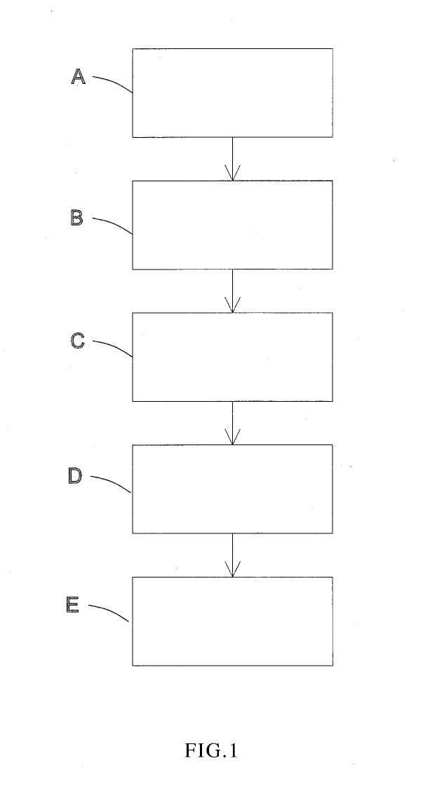

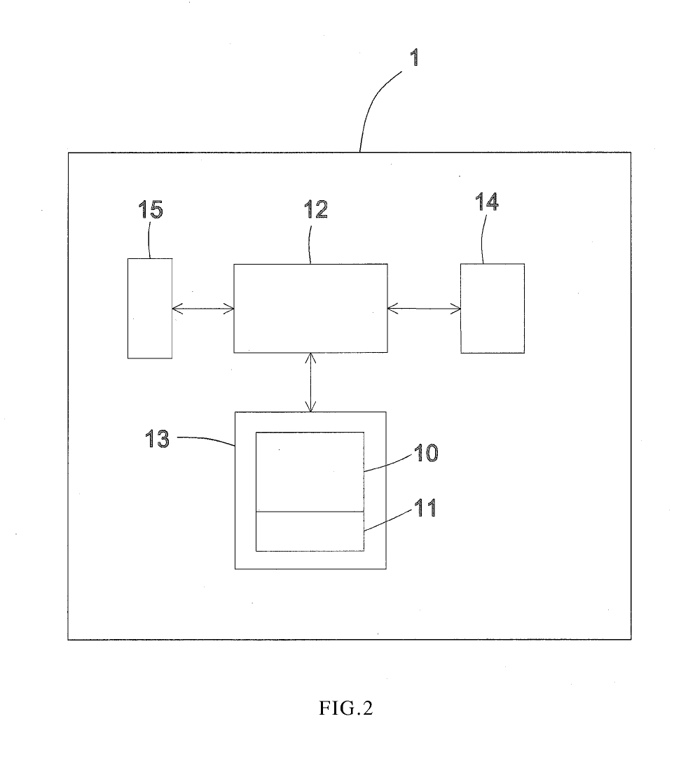

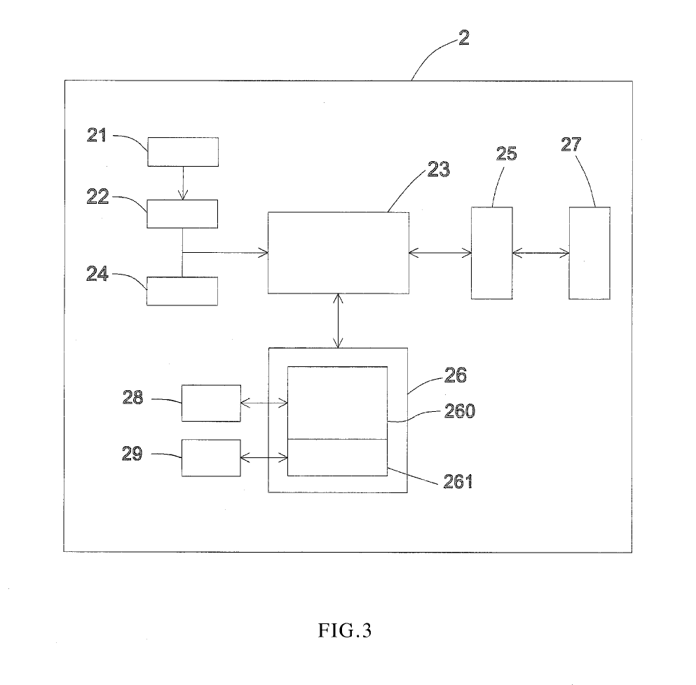

Referring to FIG. 1-8, the present invention provides a firmware upgrading method for Bluetooth electronic scales. The firmware upgrading method provides a function to resume firmware upgrading for the Bluetooth electronic scale, and conduct the Bluetooth electronic scale firmware upgrading through batch-by-batch transmission of the data packets containing parameter information. Firstly, referring to FIG. 1 depicting the schematic view of the orders of the firmware upgrading method, and further referring to FIG. 2-4, the main steps of the firmware upgrading method include: Step A: Establish Bluetooth networking; Step B: Transmit data packets; Step C: Compare the data packets in stages; Step D: Record the firmware upgrading progress; Step E: Check completeness of the upgrading.

The firmware upgrading method Step A to establish Bluetooth networking is applied for connection between the Bluetooth mobile device 1 and the Bluetooth electronic scale 2 paired through Bluetooth networking, and to establish networking based on Bluetooth Version 4.0 or higher. The Bluetooth mobile device 1 has a built-in APP Application Software program 10, a central processor 12, a cache 13, a touch screen 14 and a Bluetooth chipset 15. The APP application 10 contains an electronic scale firmware program 11. The APP application 10 uses the central processor 12 as core computing and command executing unit. The central processor 12 is respectively and electrically connected to the cache 13 and the touch screen 14. The APP application 10 and the electronic scale firmware program 11 are respectively saved in the cache 13 through address plan. By clicking the APP application 10 displayed on the touch screen 14, the central processor 12 will execute a command to read the electronic scale firmware program 11 saved in the cache 13. The Bluetooth chipset 15 of the Bluetooth mobile device 1 can conduct Bluetooth wireless communication with other Bluetooth electronic devices after pairing. The Bluetooth mobile device 1 can be a smart phone or a tablet.

The Bluetooth electronic scale 2 has a scale pan, configured with a load cell 21, a signal processing unit 22, a central processor 23, a display panel 24, a serial transmission interface unit 25, a memory 26 and a Bluetooth chipset 27. The load cell 21 detects the weighing information of the measured object placed on the scale pan. The signal processor 22 conducts filtering and amplification. And then the central processor 23 as the processing core and command executing unit will display the weighing information on the display panel 24. The serial transmission interface unit 25 is electrically connected with the Bluetooth chipset 27. The central processor 23 conducts data transmission and reception through the serial transmission interface unit 25. The Bluetooth chipset 27 of the Bluetooth electronic scale 2 establishes wireless networking with the Bluetooth chipset 15 of the Bluetooth mobile device 1 after pairing and conducts data transmission and reception. The memory 26 is a rewritable flash memory that can keep the saved data without power supply. The central processor 23 is electrically connected to the memory 26, which is loaded with a general Programming Block 260 and an ISP Programming Block (In System Programming Block) 261 through address plan. The Bluetooth electronic scale 2 has an electronic scale firmware program 28 loaded in the general Programming Block 260 to execute the weighing mode, and an ISP program (In System Programming) 29 loaded in the ISP Programming Block 261 to execute the firmware upgrading mode. The display panel 24 can choose weighing mode or firmware upgrading mode. Under the firmware upgrading mode, the central processor 23 executes the ISP program 29, and loads and upgrades the electronic scale firmware program 11 received in batches in the general Programming Block 260.

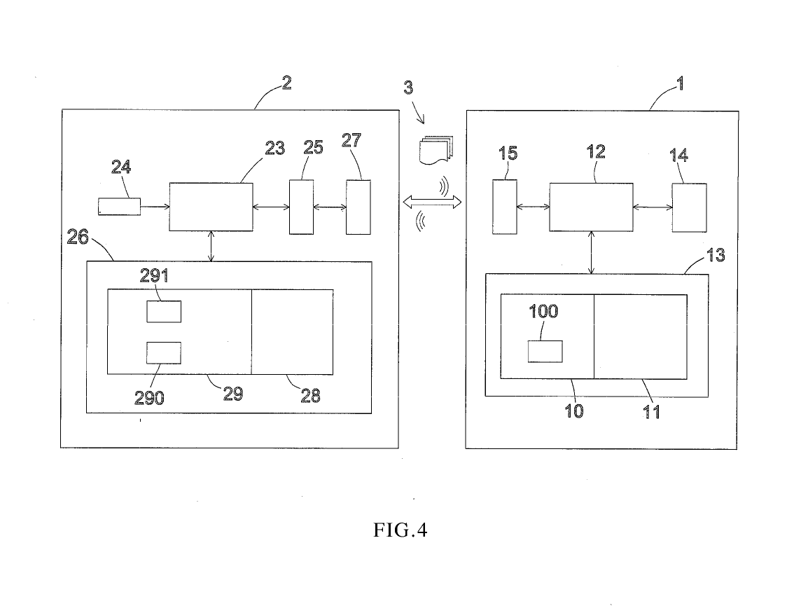

FIG. 4 shows a schematic view of the networking and data transmission between the Bluetooth mobile device and the Bluetooth electronic scale. The APP application 10 of the Bluetooth mobile device 1 transmits the electronic scale firmware program 11 to the Bluetooth electronic scale 2 in batches through Bluetooth wireless networking, to be received by the ISP program 29. The n the APP application 10 and the ISP program 29 transmits to each other data packets 3 containing parameter information.

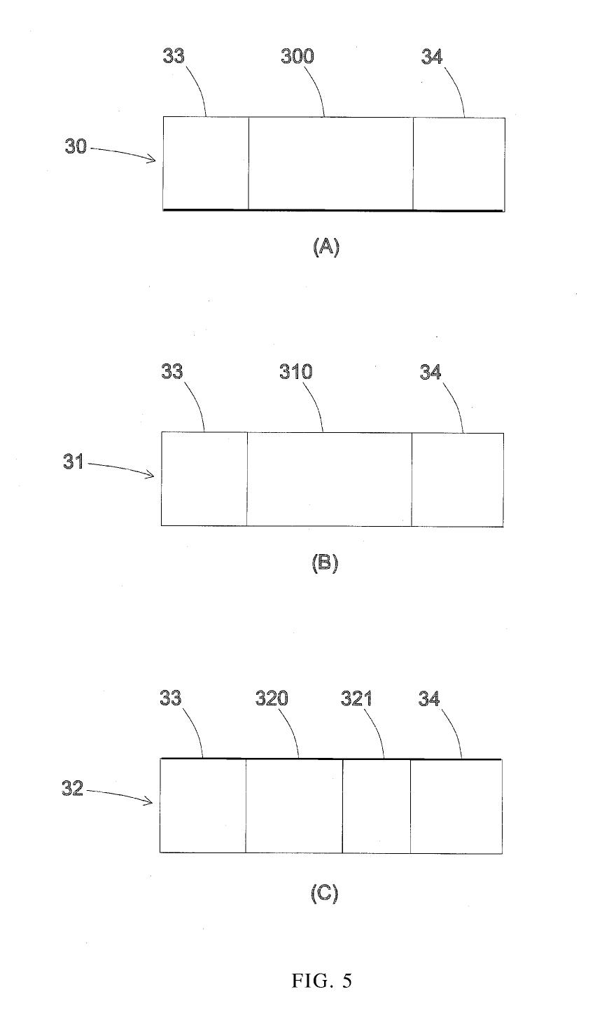

Referring to FIG. 5, which is a schematic view of the data packet categories of the present invention. As indicated by (A), (B), and (C) in the drawing, data packets are transmitted in firmware upgrading method Step B. The data packets 3 are classified into version data packet 30, firmware data packet 31, and frame data packet 32. Any of the above data packets is a packet assembly containing file header information 33 and packet checksum 34. The file header information 33 is packet identification data, containing command type, execution code, and packet length. The packet checksum 34 is the bit sum value of the data packet content. The content of the version data packet 30 is the firmware version data 300 of the electronic scale firmware program 11. The content of the firmware data packet 31 is multiple fragments of firmware data 310 split from the electronic scale firmware program 11, with maximum size up to 32 bit. The content of the frame data packet 32 further include frame data 320 and frame checksum 321. The frame data 320 is a frame numbering value compiled from 8 continuous firmware data packets 31. The frame checksum 321 is the bit sum value of the content of 8 continuous firmware data packets 31.

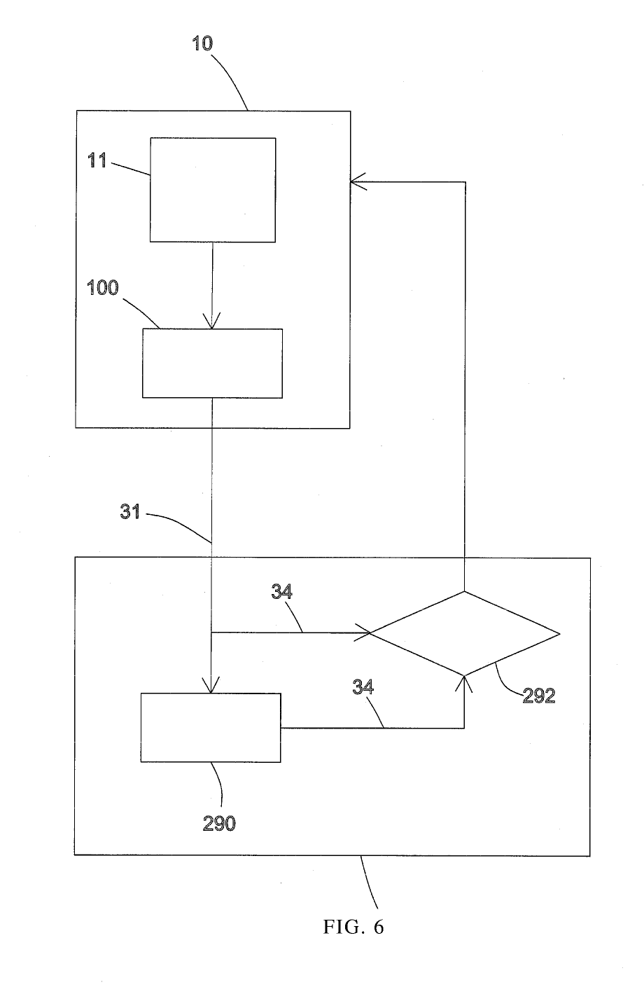

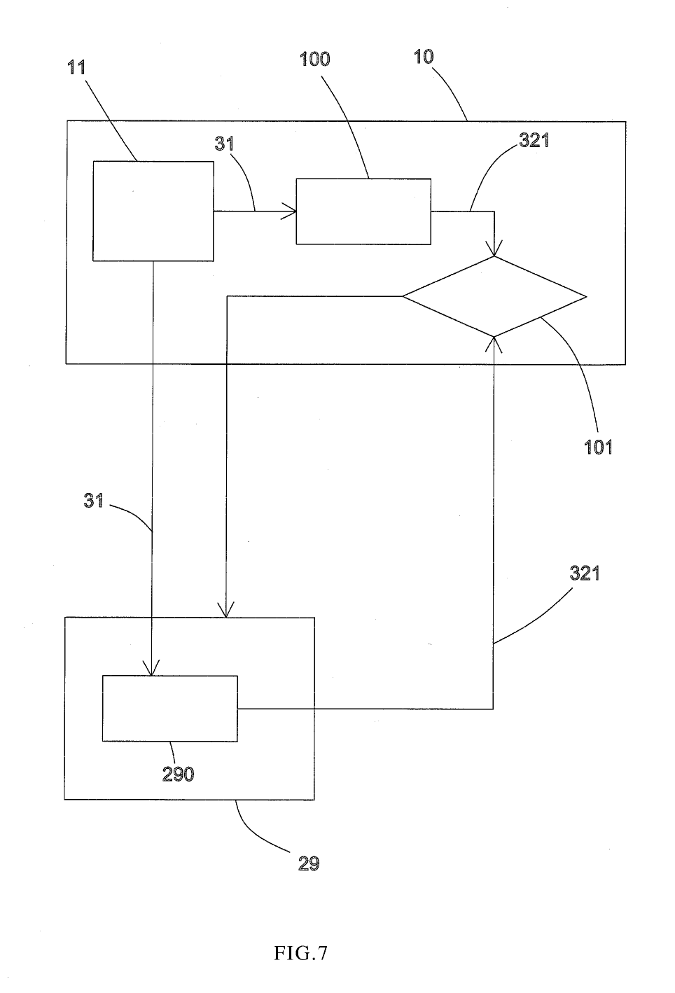

Referring to FIG. 6-7, the firmware upgrading method of the present invention has a two-stage comparing and checking mechanism to compare the data packets in Step C. Respectively, the ISP program 29 is provided with a first-stage comparing system 292 to ensure correctness of the packets received, and the APP application 10 is provided with a second-stage comparing system 101 to ensure correctness of the electronic firmware program loaded in the memory.

Referring to FIG. 6, the first-stage comparing system 292 uses the packet checksum 34 to compare and check the correctness of the firmware data packet 31. The APP application 10 is provided with a Checksum Unit A 100, and the ISP program 29 is provided with a Checksum Unit B 290. The Checksum Unit A 100 and the Checksum Unit B 290 respectively compute the packet checksum 34 of each transmitted firmware data packet 31 by mathematical operations. The ISP program 29 uses the first-stage comparing system 292 to compare and check if the checksums are the same or different. If the same, it means the reception is successful, and the firmware data packet 31 is loaded into the memory; if different, it means the reception is failed, and the ISP program 29 executes a command to request the APP application 10 to resend the firmware data packet 31.

Referring to FIG. 7, the second-stage comparing system 101 uses the frame checksum 321 to compare and check the correctness of the 8 continuous firmware data packets 31. After the ISP program successfully receives the 8 continuous firmware data packets, the ISP program 29 will execute a command to ask the APP application 10 to compare and check the frame checksum 321 of the 8 continuous firmware data packets 31. The 8 continuous firmware data packets 31 are those read by the ISP program 29 and loaded into the memory after judgment by the first-stage comparing system 292. Accordingly, the APP application 10 reads the 8 continuous firmware data packets 31 transmitted, and respectively, the APP application 10 and the ISP program 29 computes the frame checksums 321 of the 8 continuous firmware data packets 31 through Checksum Unit A 100 and Checksum Unit B 290 by mathematical operations, and compare if they are the same or different, and then the APP application 10 sends them back to the ISP program 29 and informs about the correctness. If the same, the 8 continuous firmware data packets 31 are successfully received. If different, the reception fails, and the ISP program 29 executes a command to ask the APP application 10 to resend the 8 continuous firmware data packets 31.

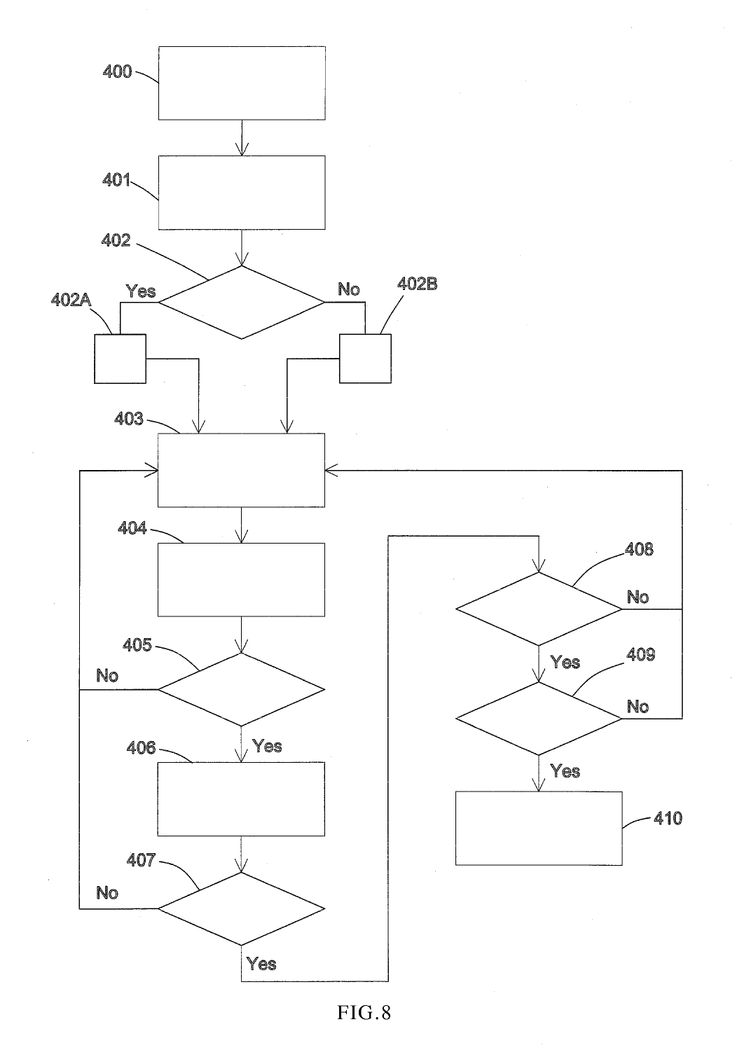

Referring to FIG. 8 depicting the complete firmware upgrading processes of the firmware upgrading method of the present invention, the firmware upgrading method includes Steps A-E. Step A is to establish Bluetooth networking, and compare the firmware programs to decide if an upgrading is needed; Step B is to transmit the data packets, and the data packets are transmitted together with parameter information; Step C is to compare the data packets in stages, which are conducted through the packet checksum and the frame checksum; Step D is to record the firmware upgrading progress, to provide a function for the Bluetooth electronic scale to resume the firmware upgrading; Finally, Step E is to check the completeness of the upgrading. For a detailed description, the firmware upgrading method are described from Step 400 to 410 as follow: Step 400: Turn on the Bluetooth electronic scale and enter the ISP program; Step 401: Bluetooth mobile device and Bluetooth electronic scale establish Bluetooth networking; Step 402: Check Bluetooth electronic scale firmware version; Step 403: APP application transmits firmware data packets; Step 404: ISP program receives firmware data packets; Step 405: ISP program compares and checks the packet checksum received; Step 406: ISP program upgrades the receiving progress variable; Step 407: ISP program saves the firmware data packets; Step 408: APP application and ISP program compare and check the frame checksum; Step 409: Judge the upgrading progress; Step 410: restart the Bluetooth electronic scale.

Below are further detailed descriptions. Referring to FIG. 1-7, initially, Step 400 is executed to turn on the Bluetooth electronic scale 2, and enter the ISP program 29, followed by Step 401, the Bluetooth mobile device 1 requests the Bluetooth electronic scale 2 for networking, and Bluetooth networking is established, then followed by Step 402, the APP application 10 requests the Bluetooth electronic scale 2 to check if firmware upgrading is needed. By transmitting the version data packet 30, compare if the current firmware data version 300 of the electronic scale firmware program 28 in the Bluetooth electronic scale 2 is the same as that of the electronic scale firmware program 11 in the APP application 10. If not the same, then conduct upgrading, and by Step 402A, reset the receiving progress variable 291, and delete the current electronic scale firmware program 28 in the Bluetooth electronic scale 2. If upgrading is not needed, by Step 402B, read the receiving progress variable 291. By Step 403, the ISP program 29 requests the APP application 10 for transmission. Upon receiving the request, the APP application 10 will be automatically directed to transmit the next firmware data packet 31 of the electronic scale firmware program 11 starting from the last receiving progress variable 291, thus the upgrading is resumed. In Step 404, Bluetooth electronic scale 2 receives a firmware data packet 31 from the ISP program 29. The first-stage comparing system 292 to compare the data packet in stages in Step C compares and checks the packet checksum 34 received by the ISP program 29 in Step 405 to see if the reception is successful. Step D to record the firmware upgrading progress is conducted by Step 406, the ISP program 29 upgrades the receiving progress variable 291, and the receiving progress variable 291 is accrued by 1. By Step 407, the ISP program saves the firmware data packet 31. If the reception fails, return to Step 403, with the receiving progress variable 291 being maintained, and request the APP application 10 to resend the packet. After the ISP program 29 successfully receives 8 firmware data packets 31, Step C will be executed to compare the data packet in stages through the second-stage comparing system 101. By Step 408, the APP application 10 and the ISP program 29 mutually compare and check the frame checksum 321. The ISP program 29 requests the APP application 10 to check the frame checksum 321, and the APP application 10 checks it and sends it back to the ISP program 29 and informs if it is correct. If incorrect, return to Step 403, the ISP program 29 requests the APP application 10 to resend the content of the 8 continuous firmware data packets 31. In Step E, the completeness of upgrading is checked, the ISP program 29 requests the APP application 10 to check the frame checksum 321, and Step 409 judges the upgrading progress, if correct, judge if it is the last frame based on the frame numbering value of the frame data 320. If yes, complete the upgrading, and restart the Bluetooth electronic scale 2. If not the last frame, return to Step 403, and continue to transmit the remaining content of the firmware data packet 31.

As a matter of fact, Bluetooth networking is susceptible to interference, and can not ensure completion of all the firmware upgrading actions in one go. Usually re-networking is needed after interruption. To cope with this problem, when the Bluetooth networking is interrupted and upgrading is paused, the firmware upgrading process of the present invention will be resumed by Step 400. After re-networking by Step 401 and judgment by Step 402, as the firmware versions are found to be the same, Step 402B is executed to read the receiving progress variable 291. Then, by Step 403, the ISP program 29 requests the APP application 10 to resume transmission of the data packets with the last receiving progress variable 291 read as the starting point, and the APP application 10 transmits the firmware data packet 31 under the next receiving progress variable 291, and execute the cycle from Step 403 through to Step 410, and finally by Step 410 the Bluetooth electronic scale 2 is restarted.

In the present invention, the Bluetooth mobile device is used to upgrade the electronic scale firmware program of the Bluetooth electronic scale. By transmitting data packets containing parameter information, the first-stage packet checksum comparing mechanism checks the correctness of the firmware data packet, and make sure the data packet received is reliable to upgrade the electronic scale firmware program. Optionally, the frame checksum can be used by the second-stage comparing and checking mechanism to ensure the correctness and reliability of the 8 continuous firmware data packets loaded in the memory of the Bluetooth electronic scale. The ISP program is provided with a receiving progress variable, so as to provide a starting point for resumption of the transmission when the networking is paused due to interruption, and to successfully upgrade the electronic scale firmware program. Finally, in consideration of the issues of transmission efficiency and resumption, the electronic scale firmware program is set to be multiple firmware data packets with fixed size up to 32 bits, in order for most efficient transmission.

Although the invention has been explained in relation to its preferred embodiment, it is to be understood that many other possible modifications and variations can be made without departing from the spirit and scope of the invention as hereinafter claimed.

1. A firmware upgrading method for Bluetooth electronic scales; the firmware upgrading method provides a function to resume firmware upgrading for the Bluetooth electronic scale, and conduct the Bluetooth electronic scale firmware upgrading through batch-by-batch transmission of the data packets containing parameter information; the steps include:
1) establish Bluetooth networking;
2) transmit data packets;
3) compare the data packets in stages;
4) record the firmware upgrading progress; and
5) check completeness of the upgrading.

2. The firmware upgrading method for Bluetooth electronic scales as claim in claim 1, wherein the firmware upgrading method Step A to establish Bluetooth networking is applied for connection between the Bluetooth mobile device and the Bluetooth electronic scale paired through Bluetooth networking; the Bluetooth mobile device has a built-in APP application (Application Software, APP), and further has an electronic scale firmware program to conduct two-way communication with the ISP program (In System Programming) provided in the Bluetooth electronic scale; the electronic scale firmware program transmits data packets containing parameter information batch by batch, which are received by the ISP program; the Bluetooth electronic scale further comprises a central processor and a memory; and the Bluetooth mobile device further comprises a central processor, a cache, and a touch screen; the Bluetooth mobile device can be a smart phone or a tablet.

3. The firmware upgrading method for Bluetooth electronic scales as claimed in claim 2, wherein the central processor of the Bluetooth electronic scale is the processing core and command execution unit; the central processor is electrically connected to the memory; the memory is loaded with a general Programming Block and an ISP Programming Block (In System Programming Block) through address plan; the ISP program is loaded in the ISP Programming Block, and the central processor executes the ISP program, and loads and upgrades the electronic scale firmware program received in batches in the general Programming Block.

4. The firmware upgrading method for Bluetooth electronic scales as claimed in claim 2, wherein the central processor of the Bluetooth mobile device is the core computing and command executing unit; the central processor is respectively and electrically connected to the cache and the touch screen; the APP application and the electronic scale firmware program are respectively saved in the cache through address plan; by clicking the APP application displayed on the touch screen, the central processor will execute a command to read the electronic scale firmware program saved in the cache, and transmit the data packets containing parameter information to the Bluetooth electronic scale in batches.

5. The firmware upgrading method for Bluetooth electronic scales as claimed in claim 2, wherein the data packets containing parameter information transmitted in the firmware upgrading method Step B mainly include firmware data packet, version data packet, and frame data packet; any of the above data packets contains file header information and packet checksum; the file header information is packet identification data, containing command type, execution code, and packet length; the packet checksum is the bit sum value of the data packet content; the content of the version data packet is the firmware version data of the electronic scale firmware program; the content of the firmware data packet is multiple fragments of firmware data split from the electronic scale firmware program with maximum size up to 32 bit; the content of the frame data packet further include frame data and frame checksum; the frame data is a frame numbering value compiled from 8 continuous firmware data packets; the frame data checksum is the bit sum value of the content of 8 continuous firmware data packets.

6. The firmware upgrading method for Bluetooth electronic scales as claimed in claim 5, wherein, during the firmware upgrading method Step A to establish Bluetooth networking, the APP application orders the Bluetooth electronic scale to check the firmware upgrading; by transmitting the version data packet and comparing the current electronic scale firmware program in the Bluetooth electronic scale with the electronic scale firmware program in the APP application to see if the firmware data versions are the same or different; if different, conduct the upgrading, and delete the current electronic scale firmware program in the Bluetooth electronic scale.

7. The firmware upgrading method for Bluetooth electronic scales as claimed in claim 5, wherein the firmware upgrading method Step C to compare the data packets in stages are conducted as follow: The ISP program is provided with a first-stage comparing system to compare and check the correctness of the firmware data packet using the packet checksum; the APP application is provided with a Checksum Unit A, and the ISP program is provided with a Checksum Unit B; the Checksum Unit A and the Checksum Unit B respectively compute the packet checksum of each transmitted firmware data packet by mathematical operations; the ISP program uses the first-stage comparing system to compare and check if the checksums are the same or different; if the same, it means the reception is successful, and the firmware data packet is loaded into the memory; if different, it means the reception is failed, and the ISP program executes a command to request the APP application to resend the firmware data packet.

8. The firmware upgrading method for Bluetooth electronic scales as claimed in claim 7, wherein the firmware upgrading method Step C to compare the data packets in stages are conducted as follow: the APP application is provided with a second-stage comparing system, which uses the frame checksum to check the correctness of the 8 continuous firmware data packets; after the ISP program successfully receives 8 continuous firmware data packets, the ISP program will execute a command to ask the APP application to compare and check the frame checksum of the 8 continuous firmware data packets; the 8 continuous firmware data packets are those read by the ISP program and loaded into the memory after judgment by the first-stage comparing system; accordingly, the APP application reads the 8 continuous firmware data packets transmitted, and respectively, the APP application and the ISP program computes the frame checksums of the 8 continuous firmware data packets through Checksum Unit A and Checksum Unit B by mathematical operations, and compare if they are the same or different; if the same, the 8 continuous firmware data packets are successfully received; if different, the reception fails, and the ISP program executes a command to ask the APP application to resend the 8 continuous firmware data packets.

9. The firmware upgrading method for Bluetooth electronic scales as claimed in claim 8, wherein the firmware upgrading method Step D to record the firmware upgrading progress provides a function to resume firmware upgrading for the Bluetooth electronic scale; the ISP program is provided with a receiving progress variable; for each firmware data packet successfully received, the receiving progress variable will be accrued by 1, and the firmware data packet will be saved; if the Bluetooth networking is interrupted and transmission is paused, return to the Bluetooth networking establishing step, and the ISP program reads the last receiving progress variable, and sends a request to the APP application; upon receiving the request, the APP application will be automatically directed to transmit the next firmware data packet of the electronic scale firmware program starting from the last receiving progress variable, thus the upgrading is resumed.

10. The firmware upgrading method for Bluetooth electronic scales as claimed in claim 9, wherein, during the firmware upgrading method Step E to check the completeness of upgrading, the ISP program orders the APP application to check the frame checksum; if correct, judge if it is the last frame based on the numbering value of the frame data; if yes, complete the upgrading, and restart the Bluetooth electronic scale; if not the last frame, continue to transmit the remaining content of the firmware data packet.
